(19) United States
(12) Patent Application Publication
(10) Pub. No.: US 2025/0327980 A1
(43) Pub. Date: Oct. 23, 2025

(54) OPTICAL CONNECTOR ASSEMBLY

(71) Applicant: AIP Inc., New Taipei City (TW)

(72) Inventor: Chia Lee, New Taipei City (TW)

(21) Appl. No.: 19/259,363

(22) Filed: Jul. 3, 2025

Related U.S. Application Data
(63) Continuation-in-part of application No. 18/510,668, filed on Nov. 16, 2023.
(60) Provisional application No. 63/528,933, filed on Jul. 26, 2023.
(60) Provisional application No. 63/730,669, filed on Dec. 11, 2024.

(51) Int. Cl. G02B 6/38

(52) U.S. Cl. CPC G02B 6/387; G02B 6/3881; G02B 6/3885; G02B 6/3893

(57) ABSTRACT

An optical connector assembly includes a first connector and an optical transmission device. The first connector includes a base mounted to a side of a photonic integrated circuit, and a waveguide device installed on the base in optical communication with the photonic integrated circuit. The second connector included in the optical transmission device is detachably connected to the first connector and includes a main body and a movable fastening member movably connected to the main body. The movable fastening member is movably fastened to the first connector in a direction perpendicular to a thickness direction of the waveguide device.

### CROSS REFERENCE TO RELATED APPLICATIONS

This application claims the benefit of U.S. provisional patent application Ser. No. 63/730,669, filed Dec. 11, 2024, the entirety of which is incorporated by reference herein.

This application is a continuation-in-part of Ser. No. 18/510,668, filed Nov. 16, 2023, which claims the priority of U.S. provisional patent application Ser. No. 63/528,933, filed Jul. 26, 2023, the entireties of which are incorporated by reference herein.

### BACKGROUND OF INVENTION

### 1. Field of Invention

The present invention relates to a technical field of optical connectors, and particularly to an optical connector assembly adapted for a photonic integrated circuit.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and may be co-packaged as co-packaged optics (CPO).

Conventional co-packaged devices are typically connected with optical fibers for optical transmission. The optical fibers are directly connected to photonic integrated circuits of co-packaged devices. However, direct optical coupling between optical fibers and photonic integrated circuits is prone to damage to photonic integrated circuits due to plugging and unplugging of the optical fibers. In other words, optical fibers connected to conventional co-packaged devices are in fact not designed for frequent connection and disconnection with optical fibers. In addition, the direct optical coupling between optical fibers and photonic integrated circuits is not conducive to adjusting apertures of optical paths between optical fibers and photonic integrated circuits, which in turn cannot improve production efficiency.

### SUMMARY OF INVENTION

An object of the present application is to provide an optical connector assembly, which is detachably connected to a photonic integrated circuit.

Another object of the present application is to provide an optical connector assembly, which allows optical fibers to be repeatedly plugged without causing damage to the photonic integrated circuit.

To achieve at least one of the above-mentioned objects, the present application provides an optical connector assembly, adapted for a photonic integrated circuit. The optical connector assembly includes a first connector and an optical transmission device. The first connector includes a base adapted to be mounted to a side of the photonic integrated circuit, and a waveguide device installed on the base and configured to be in optical communication with the photonic integrated circuit. The optical transmission device includes a plurality of optical fibers, and a second connector disposed on one end of the optical fibers and detachably connected to the first connector. The second connector includes a main body and a movable fastening member movably connected to the main body. The movable fastening member is movably fastened to the first connector in a direction perpendicular to a thickness direction of the waveguide device.

Optionally, the movable fastening member includes a hood portion positioned above the main body, a linking portion movably connected to the main body, and a bent portion connected between the hood portion and the linking portion. The hood portion is movable in conjunction with the linking portion to be fastened with the first connector.

Optionally, the second connector further includes at least a limiting member. An end portion of the limiting member is connected to a rear side of the main body, and another end portion of the limiting member is located away from the rear side of the main body. The linking portion of the movable fastening member is detachably mounted to the limiting member and movable from the another end portion of the limiting member to the rear side of the main body.

Optionally, the limiting member includes a limiting rod and an elastic component. One end of the limiting rod is connected to the rear side of the main body, and the elastic component is positioned on the limiting rod. One end of the elastic component abuts against the rear side of the main body, another end of the elastic component abuts against the linking portion, and the elastic component is deformable in length along the limiting rod.

Optionally, the movable fastening member includes a retaining structure extending from a bottom of the linking portion. The retaining structure includes a pair of fork arms structured and sized to be in a snap-fit engagement with the limiting rod.

Optionally, the first connector further includes an engaging member disposed on a rear end of the base away from the photonic integrated circuit. The hood portion is movable in conjunction with the linking portion to be fastened with the engaging member such that the engaging member is positioned between the hood portion and the main body.

Optionally, the engaging member includes an engaging protrusion positioned on an upper surface of the engaging member. The hood portion defines a fastening groove shaped and sized to be in a snap-fit engagement with the engaging protrusion.

Optionally, the hood portion includes two wing portions disposed on two opposite sides of the hood portion and bent downward toward the main body.

Optionally, the main body of the second connector includes a plurality of supporting members each extending upward from an upper surface of the main body. The wing portions are supported on the supporting members respectively in a non-fastened state with the first connector.

Optionally, the base includes a recessed portion recessed from a front end of the base and adjoining the photonic integrated circuit, and the waveguide device is installed in the recessed portion.

Optionally, the base includes at least a positioning wall integrally extending downward from the base. A corner groove is positioned at a rear end of the base away from the photonic integrated circuit and adjoins the positioning wall. Part of the main body of the second connector is positioned in the corner groove.

Optionally, the first connector further includes a plurality of positioning portions spaced apart from each other and located at a rear end of the base. The second connector further includes a plurality of locating members disposed at a front end of the main body and shaped and sized to be pluggable to the positioning portions.

Optionally, the first connector further includes a bridging element installed on the base. Part of the bridging element is positioned on the waveguide device, and another part of the bridging element is positioned on the photonic integrated circuit.

Optionally, the base includes a pair of restraining portions spaced apart from each other and protruding from a front end of the base to be positioned above the photonic integrated circuit. The bridging element is disposed between the restraining portions.

In the present application, by means of the individual arrangement of the base and the waveguide device, the optical transmission device is capable of being repeatedly plugged to the first connector mounted to the photonic integrated circuit without causing damage to the photonic integrated circuit, and the numerical apertures of the light paths created by the optical fibers, the waveguide device, and the photonic integrated circuit can be adjusted in a greater range than the light paths formed by the direct optical coupling between the optical fibers and the photonic integrated circuit, thereby there is not a large difference in numerical apertures between them to improve the optical transmission performance.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic perspective exploded view of an optical connector assembly in accordance with an embodiment of the present application.

FIG. 2 is a schematic perspective exploded view of a first connector of the optical connector assembly in accordance with an embodiment of the present application.

FIG. 3 is a schematic perspective assembly view of the first connector of FIG. 2.

FIG. 4 is a schematic perspective view of an optical transmission device of the optical connector assembly in accordance with an embodiment of the present application.

FIG. 5 is a schematic perspective view of an optical connector assembly at a bottom to rear viewing angle in accordance with an embodiment of the present application.

FIG. 6 is a schematic perspective assembly view of the optical connector assembly of FIG. 1 mounted on a load board.

FIG. 7 is a schematic perspective view showing a process of the connection between the optical transmission device and the first connector of FIG. 6.

FIG. 8 is a schematic perspective exploded view of an optical connector assembly mounted on a load board in accordance with an embodiment of the present application.

FIG. 9 is a schematic cross-sectional view showing a plurality of the optical connector assemblies of FIG. 8.

FIG. 10 is a schematic structural view showing a plurality of optical connector assemblies in FIG. 8 mounted on a load board in accordance with an embodiment of the present application.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application.

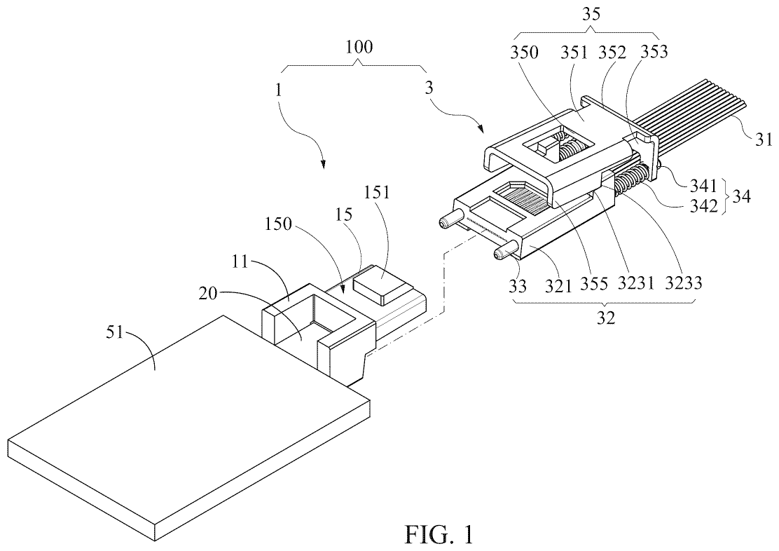

The present application provides an optical connector assembly adapted for connection with data processing devices or data sharing devices, such as switches or servers, etc., and one of the data processing devices or data sharing devices is equipped with a photonic integrated circuit. Referring to FIG. 1, which is a schematic perspective exploded view of an optical connector assembly 100 adapted for a photonic integrated circuit in accordance with an embodiment of the present application, the optical connector assembly 100 includes a first connector 1 and an optical transmission device 3. The first connector 1 is optically mounted to a side of the photonic integrated circuit 51, and the optical transmission device 3 is detachably and optically connected to the first connector 1 for optical communication between the photonic integrated circuit 51 and an applied product to which the optical transmission device 3 is connected. In some embodiments, the photonic integrated circuit 51 may be a silicon-based photonic integrated circuit, but not limited thereto.

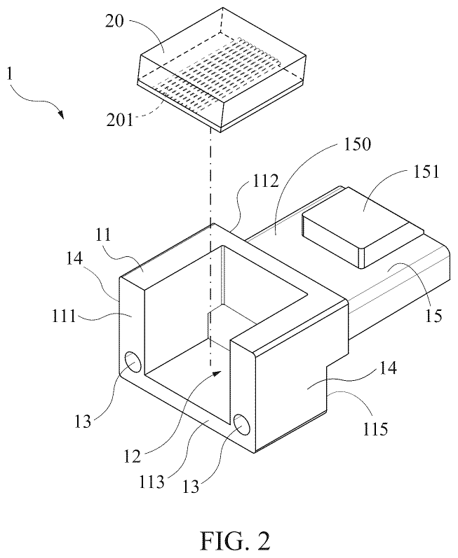

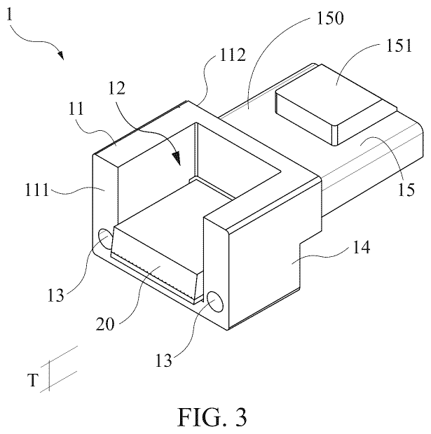

Referring to FIGS. 2 and 3 in combination with FIG. 1, the first connector 1 includes a base 11 and a waveguide device 20. The base 11 is mounted to a side of the photonic integrated circuit 51, and the waveguide device 20 is installed on the base 11 in optical communication with the photonic integrated circuit 51. The base 11 is rectangular in shape and includes a front end 111 and a rear end 112 oppositely arranged and a bottom board 113. The front end 111 is a surface of the base 11 to attach to the photonic integrated circuit 51. In some embodiments, the base 10 is made of material having the characteristic of high temperature resistance, such as ceramic or metal, which is, for example, zirconium dioxide (ZrO₂). Alternatively, the base 10 may be made of non-metal material, such as organic binders (e.g., resin), polymer, or plastic.

As shown in FIG. 2, the first connector 1 further includes an engaging member 15 disposed on the rear end 112 of the base 11 away from the photonic integrated circuit 51. Specifically, the engaging member 15 integrally extends from the rear end 112 in a direction away from the front end 111 and is perpendicular to the rear end 112. The engaging member 15 includes an engaging protrusion 151. In some embodiments, the engaging protrusion 151 is positioned on an upper surface of the engaging member 15 and protrudes upward from the upper surface of the engaging member 15 and is block-like in shape. The engaging protrusion 151 is spaced apart from the rear end 112 so that a holding space 150 is formed between the engaging protrusion 151 and the rear end 112. Preferably, the engaging protrusion 151 has a rear surface, which is curved or oblique with respect to the upper surface of the engaging member 15 for ease assembly with the optical transmission device 3. In this embodiment, a projection in a plan view of the engaging protrusion 151 entirely falls within a vertical projection of the engaging member 15 for size reduction as well as the formation of a substantially U-shaped area surrounding the engaging protrusion 151 for improvement in assembly strength with the optical transmission device 3.

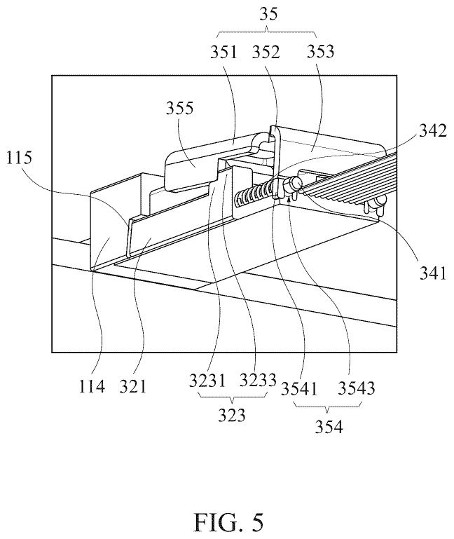

Still referring to FIG. 2, the base 11 includes a pair of positioning walls 14 spaced apart from each other and integrally extending downward from the base 11, and the bottom board 113 is connected between the positioning walls 14. A corner groove 115 is positioned at the rear end 112 of the base 11 away from the photonic integrated circuit 51 and adjoins the positioning wall 14. The corner groove 115 is located below the engaging member 15 and is configured to prevent the optical transmission device 3 from being displaced in a vertical direction (as shown in FIG. 5, which will be described later). As shown in FIG. 2, the first connector 1 further includes two positioning portions 13 arranged on the positioning walls 14 and spaced apart from each other. Each of the positioning portions 13 extends through the rear end 112 of the base 11 and is exposed to and faces the corner groove 115. In some embodiments, the positioning portions 13 are groove-like in shape.

As shown in FIGS. 1 to 3, the base 11 defines a recessed portion 12 recessed from a front end 111 of the base 11 and adjoining the photonic integrated circuit 51. In this embodiment, as shown in FIG. 3, the waveguide device 20 is installed in the recessed portion 12. Specifically, the positioning walls 14, the bottom board 113, and the rear end 112 of the base 11 surround to form the recessed portion 12 in such a way that the recessed portion 12 passes through the rear end 112 and is open to outside at the front end 111, a top, and the rear end 112 of the base 11. The waveguide device 20 is disposed in the recessed portion 12 with part of the waveguide device 20 extending out of the bottom board 113 and exposed at the rear end 112. As shown in FIG. 2, a plurality of optical waveguide path 201 are arranged in the waveguide device 20 for light signal transmission. Specifically, an optical coupling surface is defined at a front of the waveguide device 20 and is an inclined surface, preferably eight-degree inclined, with respect to the photonic integrated circuit 51 in order to prevent the interference of reflected light during optical transmission.

In some embodiments, the recessed portion 12 may be omitted, that is, the waveguide device 20 may be positioned directly on an upper surface of the base 11. In the absence of the recessed portion 12, the efficiency of assembly of the waveguide device 20 on the base 11 and the strength of assembly are inferior to the presence of the recessed portion 12 in the base 11.

The waveguide device 20 is preferably made of a material containing, for example, silica. Alternatively, the waveguide device 20 may be made of a material containing silicon-on-insulator (SOI), lithium niobate (LiNbO₃), or polymers. The waveguide device 20 may be formed using a material of such as fused silica, quartz, glass, borosilicate glass, etc. In some embodiments, the waveguide device 20 includes a planar lightwave circuit (PLC). In some embodiments, the planar lightwave circuit may be configured in various ways, including, but not limited to, a straight line circuit, a splitter circuit, an arrayed waveguide grating wavelength multiplexer, and a cross connect-type circuit. Different types of waveguide circuits or devices can be utilized for the planar lightwave circuit in the embodiments of the present application.

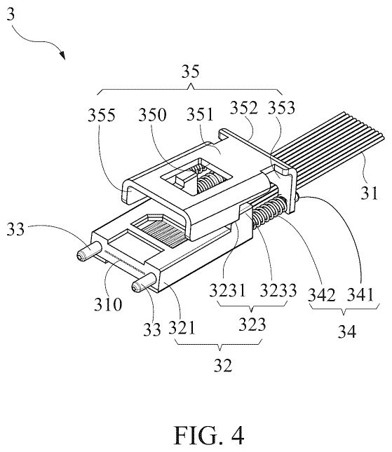

Referring to FIG. 4 in combination with FIG. 1, FIG. 4 is a schematic perspective view of the optical transmission device 3 of the optical connector assembly 100. The optical transmission device 3 includes a plurality of optical fibers 31, a second connector 32, a plurality of locating members 33, a plurality of limiting member 34, and a movable fastening member 35. Specifically, the second connector 32 is disposed on one end of the optical fibers 31 to terminate the optical fibers 31 and is detachably connected to the first connector 1. In some embodiments, the second connector 32 includes a main body 321 and a plurality of supporting members 323. In detail, the supporting members 323 extend upward from an upper surface of the main body 321. The supporting members 323 are spaced apart from each other and each of the supporting members 323 includes a first step portion 3231 and a second step portion 3233. The second step portion 3233 adjoins the first step portion 3231 and is located higher than the first step portion 3231. The supporting members 323 are configured for ease assembly of the second connector 32 and the first connector 31 that will be further described later.

As shown in FIG. 4, two locating members 33 are spaced apart from each other and extend frontward from a front surface of the main body 321. In this embodiment, the locating members 33 are pin-like in shape and shaped and sized to snugly fit and pluggable to the groove-like positioning portions 13 of the base 11. The optical fibers 31 have fiber ends 310 exposed at the front surface of the main body 321 between the locating members 33.

As shown in FIGS. 1 and 4, in this embodiment, the movable fastening member 35 is movably connected to the main body 321 through the limiting members 34. Specifically, two limiting members 34 are disposed at a rear side of the main body 321 opposite to the fiber ends 310. In detail, an end portion of each of the limiting members 34 is connected to the rear side of the main body 321, and another end portion of the limiting member 34 is located away from the rear side of the main body 321. In this embodiment, each of the limiting members 34 includes a limiting rod 341 and an elastic component 342. One end of the limiting rod 341 is connected to the rear side of the main body 321, and the elastic component 342 is positioned on the limiting rod 341. Preferably, the elastic component 342 is a compressed spring, and the limiting rod 341 is inserted into the elastic component 342. The elastic component 342 is deformable in length along the limiting rod 341 due to a pressing force applied by the movable fastening member 35, or the pressing force is released.

Still referring to FIGS. 1 and 4, the movable fastening member 35 may be made of a material including metal, plastic, or ceramic. Specifically, the movable fastening member 35 includes a hood portion 351 positioned above the main body 321, a linking portion 353 movably connected to the main body 321, and a bent portion 352 connected between the hood portion 351 and the linking portion 353. Preferably, the hood portion 351, the bent portion 352, and the liking portion 353 are a one-piece element and jointly form a substantially inverse L shape and a cantilever structure. A fastening groove 350 is formed to penetrate the hood portion 351 and is shaped and sized to be in a snap-fit engagement with the engaging protrusion 151 of the first connector 1. Specifically, the linking portion 353 is detachably mounted to the limiting member 34 and movable from the other end portion of the limiting member 34 to the rear side of the main body 321.

Referring to FIG. 5, the movable fastening member 35 includes two retaining structures 354 spaced apart from each other and extending from a bottom of the linking portion 353. In this embodiment, each of the retaining structure 354 includes a pair of fork arms 3541 defining a clamping slot 3543 formed between the fork arms 3541. The fork arms 3541 and the clamping slot 3543 are shaped and sized to be in a snap-fit engagement with the limiting rod 341. One end of the elastic component 342 abuts against the rear side of the main body 321, another end of the elastic component 342 abuts against the linking portion 353. Specifically, the clamping slot 3543 is open along a lower edge of the retaining structure 354 and has an upper width greater than a lower width so as to longitudinally retain the retaining structure 354 on the limiting rod 341. A rear end portion of the limiting rod 341 has a diameter greater than the upper width of the clamping slot 3543, so that the retaining structure 354 is transversally limited between the rear end portion of the limiting rod 341 and the elastic component 342. In this fashion, the movable fastening member 35 is movable from a position away from the main body 321 to the rear side of the main body 321, or from the rear side of the main body 321 to the position away from the main body 321, that is, the linking portion 353 is movable within the length range of the limiting rod 341.

As shown in FIGS. 4 and 5, the hood portion 351 includes two wing portions 355 disposed on two opposite sides of the hood portion 351 and bent downward toward the main body 321. The wing portions 355 are supported on the supporting members 323, respectively, in a non-fastened state with the first connector 1. Specifically, a rear end of the wind portion 355 is retained against the second step portion 3233 such that the hood portion 351 tilts with respect to the main body 321 to enlarge a space between the hood portion 351 and the main body 321 for ease of assembly between the second connector 32 and the first connector 1.

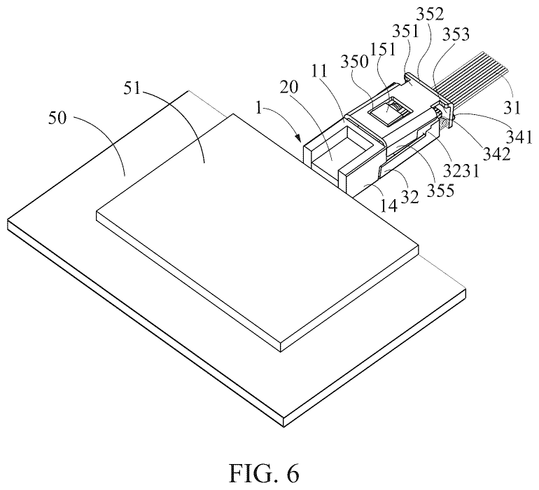

Referring to FIGS. 5 and 6 in combination with FIG. 1, FIG. 6 is a schematic assembly view of the optical connector assembly 100 of FIG. 1 mounted on a load board 50. The optical transmission device 3 is detachably connected to the first connector 1 in a direction perpendicular to a thickness direction T of the waveguide device 20 (as shown in FIG. 3). Specifically, the hood portion 351 is movable in conjunction with the linking portion 353 to be fastened with the engaging member 15 such that the engaging member 15 is positioned between the hood portion 351 and the main body 321 of the second connector 32. More specifically, the hood portion 351 is pushed forward to move to the first connector 1, and the locating members 33 are snugly inserted to the positioning portions 13. At the same time, the hood portion 351 is guided by the engaging protrusion 151. When the hood portion 351 is continuously pushed forward until it reaches the holding space 150, the hood portion 351 is pressed downward so that the fastening groove 350 engages with the engaging protrusion 151, and a front part of the hood portion 351 is positioned in the holding space 150. Concurrently, as shown in FIG. 6, upon the engaging protrusion 151 is engaged with the hood portion 351 in the fastening groove 350, the rear end of the wing portion 355 is retained on the second connector 32 in front of the first portion 3231, and the elastic component 342 applies a push force on the retaining structure 354 to appropriately tighten the engagement between the hood portion 351 and the engaging protrusion 151. In this manner, the second connector 32 can be easily and firmly connected with the first connector 1.

The following is to explain in detail about the assembly of the optical connector assembly 100 and the photonic integrated circuit 51 disposed on a load board 50. The first connector 1 connected with the optical transmission device 3 is firstly positioned on the photonic integrated circuit 51, and the first connector 1 is actively aligned with a signal transmission portion (not labelled) of the photonic integrated circuit 51 with optical monitoring to enable signal transmission between the optical transmission device 3 and the photonic integrated circuit 51 through the waveguide device 20. That is, the light signal is optically coupled to the photonic integrated circuit 51 through the waveguide device 20 rather than being directly transmitted to the photonic integrated circuit 51, which can improve the variation of numerical apertures of light paths when the light signal is transmitted from the optical fibers 31 to the photonic integrated circuit 51, and also prevent the photonic integrated circuit 51 from being damaged by the direct contact with the optical fibers 31 and the second connector 32 in terms of repeated plugging of the second connector 32.

It should be noted that the material property and structure of the photonic integrated circuit 51 may significantly hinder the variation range of the numerical apertures of the light paths when the light signal transmission is directly created between the optical fibers 31 and the photonic integrated circuit 51, which is the problem that can be addressed by the detachable structure of the base 11 and the waveguide device 20 of the present application as described above. In addition, the arrangement of the base 11 and the waveguide device 20, which is separate from the photonic integrated circuit 51, is conducive to improving the production efficiency as well as customized production since the formation of the first connector 1 is separate from the photonic integrated circuit in comparison with the light paths are formed in the photonic integrated circuit without the waveguide device.

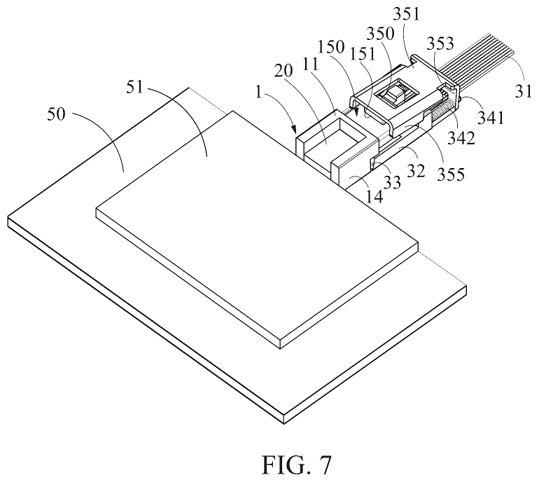

Referring to FIG. 7 in combination with FIG. 1, in detaching the optical transmission device 3, the fastening groove 350 is lifted up to disengage from the engaging protrusion 151, so that the elastic component 342 automatically pushes the linking portion 353 to move away from the second connector 32. Then, the second connector 32 can be detached from the base 11. Specifically, after the first connector 1 is positioned in place on the photonic integrated circuit 51, the optical transmission device 3 is detached from the first connector 1, and at least a reflow process or a back-end process is performed on the first connector 1 and the photonic integrated circuit 51 in combination with the load board 50. After the photonic integrated circuit 51 with the first connector 1 is co-packaged with the load board 50, the optical transmission device 3 is plugged to the first connector 1 again for enabling light signal transmission between the photonic integrated circuit 51 and the optical transmission device 3. In doing so, the optical transmission device 3 would not be damaged by the elevated temperatures during the above-mentioned processes.

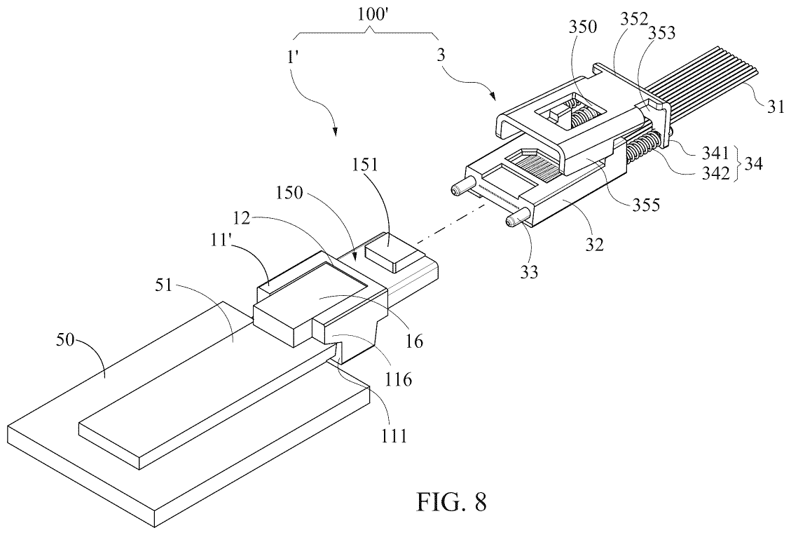

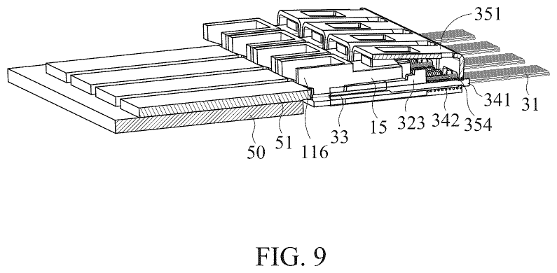

Referring to FIGS. 8 and 9, FIG. 8 is a schematic perspective exploded view of an optical connector assembly 100′ mounted on a load board 50 in accordance with an embodiment of the present application, and FIG. 9 is a schematic cross-sectional view showing a plurality of the optical connector assemblies 100′ of FIG. 8. The optical connector assembly 100′ is mainly different from the optical connector assembly 100 in that a bridging element 16 and a plurality of restraining portions 116 are provided in the first connector 1′. It should be noted that the other components of the optical connector assembly 100′ are the same as those of the optical connector assembly 100 and therefore will not be described in detail here. The bridging element 16 is omitted in FIG. 9 for clarity of the connection between the restraining portion 116 and the photonic integrated circuit 51. As shown in FIG. 8, the base 11′ further includes the bridging element 16 to connect the photonic integrated circuit 51 and the waveguide device 20. Specifically, part of the bridging element 16 is disposed in the recessed portion 12 and positioned on the waveguide device 20, which is covered by the bridging element 16, and another part of the bridging element 16 extends to a certain length on the photonic integrated circuit 51 such that part of the photonic integrated circuit 51 is sandwiched between the bridging element 16 and the load board 50. That is, the bridging element 16 serves to enhance the structural strength of the photonic integrated circuit 51 and provides the structural force to combine the photonic integrated circuit 51 and the waveguide device 20, especially when the photonic integrated circuit 51 is too thin, which may cause the warpage of the photonic integrated circuit 51, thereby ensuring a reliable optical connection between the photonic integrated circuit 51 and the waveguide device 20.

In some other embodiments, the photonic integrated circuit 51 is thick enough to withstand the warpage, so that optical connector assembly 100′ includes the restraining portion 116 but not the bridging element 16. As shown in FIGS. 8 and 9, the base 11 includes a pair of restraining portions 116 spaced apart from each other and protruding from a front end of the base 11. The restraining portions 116 are positioned above the photonic integrated circuit 51, and the bridging element 16 is disposed between the restraining portions 116. The restraining portions 116 are configured to prevent the first connector 1 from being displaced in a vertical direction and also ensure the bridging element 16 is retained in the recessed portion 12.

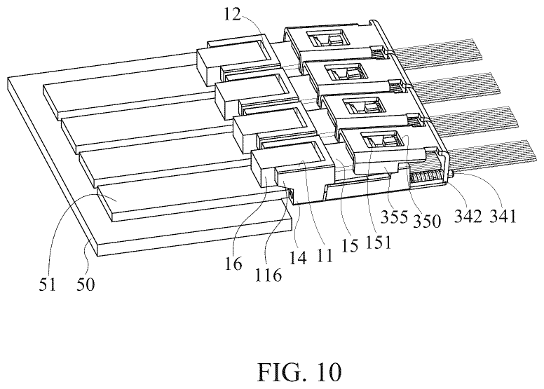

Referring to FIG. 10, which is a schematic structural view showing a plurality of the optical connector assemblies 100′ in FIG. 8 mounted on the load board 50, in another embodiment, each side of the load board 50 may be equipped with four photonic integrated circuits 51 each connected with the optical connector assembly 100/100′ (not shown). It should be noted that the number of the photonic integrated circuits 51 is varied according to actual requirements.

Accordingly, in the present application, by means of the individual arrangement of the base and the waveguide device, the optical transmission device is capable of being repeatedly plugged to the first connector mounted to the photonic integrated circuit without causing damage to the photonic integrated circuit, and the numerical apertures of the light paths created by the optical fibers, the waveguide device, and the photonic integrated circuit can be adjusted in a greater range than the light paths formed by the direct optical coupling between the optical fibers and the photonic integrated circuit, thereby there is not too large a difference in numerical apertures between them to improve the optical transmission performance.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An optical connector assembly, adapted for a photonic integrated circuit, the optical connector assembly comprising:
a first connector comprising:
a base adapted to be mounted to a side of the photonic integrated circuit; and
a waveguide device installed on the base and configured to be in optical communication with the photonic integrated circuit; and
an optical transmission device comprising:
a plurality of optical fibers; and
a second connector disposed on one end of the optical fibers and detachably connected to the first connector, wherein the second connector comprises a main body and a movable fastening member movably connected to the main body, and the movable fastening member is movably fastened to the first connector in a direction perpendicular to a thickness direction of the waveguide device.

2. The optical connector assembly of claim 1, wherein the movable fastening member comprises a hood portion positioned above the main body, a linking portion movably connected to the main body, and a bent portion connected between the hood portion and the linking portion, wherein the hood portion is movable in conjunction with the linking portion to be fastened with the first connector.

3. The optical connector assembly of claim 2, wherein the second connector further comprises at least a limiting member, an end portion of the limiting member is connected to a rear side of the main body, and another end portion of the limiting member is located away from the rear side of the main body, and wherein the linking portion of the movable fastening member is detachably mounted to the limiting member and movable from the another end portion of the limiting member to the rear side of the main body.

4. The optical connector assembly of claim 3, wherein the limiting member comprises a limiting rod and an elastic component, one end of the limiting rod is connected to the rear side of the main body, and the elastic component is positioned on the limiting rod, and wherein one end of the elastic component abuts against the rear side of the main body, another end of the elastic component abuts against the linking portion, and the elastic component is deformable in length along the limiting rod.

5. The optical connector assembly of claim 4, wherein the movable fastening member comprises a retaining structure extending from a bottom of the linking portion, and the retaining structure comprises a pair of fork arms structured and sized to be in a snap-fit engagement with the limiting rod.

6. The optical connector assembly of claim 2, wherein the first connector further comprises an engaging member disposed on a rear end of the base away from the photonic integrated circuit, and the hood portion is movable in conjunction with the linking portion to be fastened with the engaging member such that the engaging member is positioned between the hood portion and the main body.

7. The optical connector assembly of claim 6, wherein the engaging member comprises an engaging protrusion positioned on an upper surface of the engaging member, and the hood portion defines a fastening groove shaped and sized to be in a snap-fit engagement with the engaging protrusion.

8. The optical connector assembly of claim 2, wherein the hood portion comprises two wing portions disposed on two opposite sides of the hood portion and bent downward toward the main body.

9. The optical connector assembly of claim 8, wherein the main body of the second connector comprises a plurality of supporting members each extending upward from an upper surface of the main body, and the wing portions are supported on the supporting members respectively in a non-fastened state with the first connector.

10. The optical connector assembly of claim 1, wherein the base comprises a recessed portion recessed from a front end of the base and adjoining the photonic integrated circuit, and the waveguide device is installed in the recessed portion.

11. The optical connector assembly of claim 1, wherein the base comprises at least a positioning wall integrally extending downward from the base, a corner groove is positioned at a rear end of the base away from the photonic integrated circuit and adjoins the positioning wall, and part of the main body of the second connector is positioned in the corner groove.

12. The optical connector assembly of claim 1, wherein the first connector further comprises a plurality of positioning portions spaced apart from each other and located at a rear end of the base, the second connector further comprises a plurality of locating members disposed at a front end of the main body and shaped and sized to be pluggable to the positioning portions.

13. The optical connector assembly of claim 1, wherein the first connector further comprises a bridging element installed on the base, part of the bridging element is positioned on the waveguide device, and another part of the bridging element is positioned on the photonic integrated circuit.

14. The optical connector assembly of claim 13, wherein the base comprises a pair of restraining portions spaced apart from each other and protruding from a front end of the base to be positioned above the photonic integrated circuit, and the bridging element is disposed between the restraining portions.
